(19) United States
(12) Patent Application Publication
(10) Pub. No.: US 2025/0015757 A1
(43) Pub. Date: Jan. 9, 2025

(54) OVERVOLTAGE PROTECTION ADAPTER AND METHODS THEREOF

(71) Applicant: Andrew Cardenas, Tehachapi, CA (US)

(72) Inventor: Andrew Cardenas, Tehachapi, CA (US)

(21) Appl. No.: 18/766,460

(22) Filed: Jul. 8, 2024

Related U.S. Application Data
(60) Provisional application No. 63/525,589, filed on Jul. 7, 2023.

(51) Int. Cl. H02S 40/34; H02S 20/32

(52) U.S. Cl. CPC H02S 40/345; H02S 20/32

(57) ABSTRACT

An overload protection adapter incorporated into the control panel of a solar tracking array, the adapter being operable to interface between a motor wiring and a motor control panel. The adapter is operable to be incorporated into new and existing solar tracking array systems and provides over voltage and current protection to the motor and control panel circuits.

### FIELD OF THE INVENTION

The present invention relates generally to an overload protection adapter that is operable to protect electronic components. More particularly, the present invention provides a protection adapter that interfaces between a solar panel tracking motor and the control panel. The adapter is configured to protect existing solar tracking control panels and arrays without replacing the motor logic board.

### BACKGROUND OF THE INVENTION

Solar trackers orient solar panels to track the sun's movement across the sky throughout the day, optimizing the quantity of sunlight the panels capture and enhancing their power generation. A motor, affixed to the frame and connected to the panel, determines the panel's position. The motor uses a wiring system typically consisting of four wires, which are connected to a control panel. Both motors and solar panels are exposed to a variety of environmental conditions, making them susceptible to mechanical interference, control system errors, and electrical failures. Such electrical failures within the motor, wiring, or control panel can inflict irreparable harm on the system's electronics, often necessitating their replacement.

Modern control systems for solar tracking arrays typically incorporate circuit protection or circuit breakers on the control board to prevent excessive current flow in the motor or panel circuits. However, older, and outdated systems lack these protective circuits. Various fuse harnesses are available, including blade, glass tube, resettable, thermal, and high voltage fuse harnesses. Despite this, none of these harnesses are specifically designed to protect the motor and control panel from damage. A plug-n-play solution to overcome the shortcoming of the products available is needed.

### SUMMARY OF THE INVENTION

The present invention provides an overload protection adapter that is operable to be incorporated into a solar panel tracking motor wiring and a motor driver control board. The adapter may be operable to prevent excessive current and voltage from damaging the motor and the control board of the solar tracking array of panels. The adapter may include a first connector and a second end connector having wiring therebetween and two independent protection circuits inline with the forward and reverse voltage connections. The first end of the connector may connect to the wiring from the motor control line and the second end may connect to the motor driver board. The adapter may be incorporated into existing and outdated solar tracking array control panels and may connect to the system between the wiring from the motor and the motor control board.

In some embodiments, the adapter may have an inline fuse connector that is operable to receive a bladed fuse clip that has a rating corresponding to the voltage and current rating of the motor. The first and second end connectors may be a Molex type connector corresponding to the connector type of the motor wiring and the connector type of the receiver on the motor driver control board.

In some embodiments, the inline fuse connector may receive axial lead fuses, blade terminal cartridge fuse, ceramic fuse, fast-acting fuse, glass tube, high speed fuse, liquid fuse, medium voltage fuse, and time delay fuse. Each fuse is available in a wide range of sizes, wiring configurations, and power/voltage ratings. In some embodiments, the inline fuse connector may be replaced with a circuit breaker, thereby allowing for resetting the breaker without replacing the fuse.

The overvoltage protection adapter is designed to integrate seamlessly into multi-solar panel arrays, enhancing the reliability and longevity of the system. In a multi-solar panel array, several solar panels are connected in series or parallel configurations to maximize energy capture and efficiency. Each panel is equipped with a solar tracker, which adjusts the panel's orientation throughout the day to follow the sun's movement. This tracking system is driven by motors, which are controlled by a central control panel.

To install the overvoltage protection adapter, the motor wiring and motor driver control board of the solar tracking system. The wiring typically consists of multiple wires that transmit power and control signals between the motor and the control panel. The adapter is then installed between the motor wiring and the motor driver control board. The first connector of the adapter attaches to the motor wiring, while the second connector interfaces with the motor driver board. This ensures that all electrical signals pass through the adapter before reaching the control panel. The adapter contains inline fuse connectors selected based on the voltage and current ratings of the motor and control board, ensuring optimal protection.

Once installed, the adapter continuously monitors the electrical current flowing between the motor and the control panel. If the current exceeds a predetermined threshold, indicating a potential overvoltage or overcurrent condition, the fuse within the adapter will sever or a circuit breaker will trip. This action disconnects the circuit, preventing excessive current from reaching the motor and control board, thereby protecting these components from damage. In practical use, the adapter provides overcurrent protection in case of a short circuit or electrical fault within the motor or wiring, preventing high current from damaging the control board. It also offers surge protection against voltage surges that can occur due to lightning strikes or other external electrical disturbances. Additionally, the adapter can be easily retrofitted into older solar panel arrays that lack modern protective circuits, upgrading their safety without the need to replace existing control panels or motor systems.

The overvoltage protection adapter prevents electrical faults from damaging the motor and control panel, thereby reducing the risk of costly repairs and replacements. The adapter also minimizes the risk of electrical fires by disconnecting the circuit during an overcurrent condition, enhancing overall system safety. Its retrofit capability allows for the upgrading of older solar panel systems without the need for complete system overhauls, making it a cost-effective solution for enhancing protection. By preventing electrical damage, the adapter extends the lifespan of critical components, reducing maintenance costs and downtime. The adapter is adaptable to a wide range of fuse types, allowing for customization based on specific system requirements. In some configurations, a circuit breaker can replace the fuse, offering resettable protection and eliminating the need for fuse replacement after each fault.

Improved system reliability is another significant benefit. The protection provided by the adapter ensures that the solar panel array can operate reliably even in adverse electrical conditions. By preventing damage and maintaining system integrity, the adapter helps ensure continuous energy production, maximizing the efficiency and output of the solar panel array. In conclusion, the overvoltage protection adapter is a crucial component for enhancing the safety, reliability, and longevity of multi-solar panel arrays. Its ability to protect against electrical faults and surges makes it an invaluable addition to both new and existing solar tracking systems.

Some embodiments include an overvoltage protection adapter designed to enhance the safety and reliability of solar panel tracking systems for retrofitting existing solar panel arrays without necessitating the replacement of motor driver control boards. The inline fuse device may incorporate one or more fuses in electrical connection with both a solar panel tracking motor and a controller. The solar panel tracking motor may be operable to adjust the position of one or more solar panels, each including at least one photovoltaic cell. The controller provides the necessary control signals for the motor. The inline fuse connectors within the device disconnect and open the circuit between the motor and the controller when the current passing through the fuses exceeds a predetermined threshold, thereby preventing damage.

The device may include a first connector operable to connect to the motor wiring and a second connector operable to connect to the controller. The inline fuse connectors may be positioned between these first and second connectors and operable to house various types of fuses. These fuses can include axial lead fuses, blade terminal fuses, cartridge fuses, ceramic fuses, DC power distribution fuses, dummy fuses, fast-acting fuses, glass tube fuses, high-speed fuses, liquid fuses, medium voltage fuses, terminal fuses, and time delay fuses. This variety ensures compatibility with different system requirements. In addition to traditional fuses, the inline fuse connectors can be configured to house circuit breakers. These can be selected from electronic circuit breakers, thermal circuit breakers, magnetic circuit breakers, and thermal-magnetic circuit breakers, providing further flexibility and protection.

The protection circuit within the device is operable to disconnect the circuit when the current exceeds a predetermined threshold value, which may correspond to the rated current of the motor wiring. The device may include a resettable circuit breaker in place of the inline fuse connector, allowing for easy reset after a fault condition. The adapter can be equipped with an environmental protective casing that encloses the first and second connectors and the inline fuse connectors. This casing protects the device from harsh environmental conditions. The device include a thermal protection element to prevent overheating and an indicator light that signals when a fuse is blown or a circuit breaker is tripped. In some embodiments, a microcontroller is included to monitor the current and activate the protection circuit when a fault condition is detected.

The adapter is versatile and can operate in both single-axis and dual-axis solar tracking systems. It is compatible with various types of solar panel tracking motors, including stepper motors and servo motors. The design of the inline fuse connectors allows for easy replacement of fuses without disassembling the adapter, ensuring convenient maintenance and continued operation.

The present invention provides a method of preventing overvoltage in a photovoltaic system using an overvoltage protection adapter. The adapter is designed to be electrically connected to the motor wiring of a solar tracker motor and a motor driver control board, including a first connector configured to connect to the motor wiring and a second connector configured to connect to the motor driver control board. The inline fuse connector is operable to house one or more fuses, is positioned between the first and second connectors. In operation, the overvoltage protection adapter continuously monitors the current flow through the motor wiring and the motor driver control board. When the current exceeds a predetermined threshold, the inline fuse connector disconnects the circuit between the motor wiring and the motor driver control board. This action prevents excessive current from reaching the motor driver control board, thereby protecting it from damage.

In some implementations, the overvoltage protection adapter resets after a power surge. A resettable circuit breaker may be included in place of the inline fuse connector. This feature allows for easy resetting of the protection mechanism without the need to replace fuses after each fault. Additionally, the adapter may be equipped with an environmental protective casing that encloses the first and second connectors and the inline fuse connectors, providing enhanced durability and protection against environmental factors.

The overvoltage protection adapter may further protect against overheating through a thermal protection element to prevent overheating. The adapter is also operable to receive a bladed fuse clip that corresponds to the voltage and current rating of the motor, allowing for easy customization and replacement of fuses based on specific system requirements.

The invention also provides a method of preventing damage to circuitry in a photovoltaic system by electrically connecting an inline fuse device to an electrical motor and a controller. The electrical motor is operable to adjust the position of one or more solar panels, each including at least one photovoltaic cell. The controller provides control signals to the motor. The inline fuse device includes one or more fuses that disconnect and open the circuit between the motor and the controller when the current passing through the fuses exceeds a predetermined threshold. This method ensures that the electrical motor and controller are protected from damage due to excessive current, thereby maintaining the integrity and functionality of the photovoltaic system.

In summary, the overvoltage protection adapter and methods of the present invention provides a robust, adaptable, and easy-to-install solution for protecting solar panel tracking systems from overcurrent and overvoltage conditions, enhancing the overall reliability and safety of photovoltaic installations.

Further aspects and embodiments will be apparent to those having skill in the art from the description and disclosure provided herein.

It is an object of the present invention to provide an overload protection adapter that is operable to retrofit existing solar array control panels and motor combinations and provide protection to the system without replacement of the control panel circuit boards.

It is an object of the present invention to provide methods of electrical overload protection operable to retrofit existing solar array control panels and motor combinations and protect to the system without replacement of the control panel circuit boards.

The above-described objects, advantages, and features of the invention, together with the organization and manner of operation thereof, will become apparent from the following detailed description when taken in conjunction with the accompanying drawings, wherein like elements have like numerals throughout the several drawings described herein. Further benefits and other advantages of the present invention will become readily apparent from the detailed description of the preferred embodiments.

### BRIEF DESCRIPTION OF THE DRAWINGS

FIG. 1 provides an environmental view of a solar array connected to a control panel, according to an embodiment of the present invention.

FIG. 2 provides an illustration of a control panel, according to an embodiment of the present invention.

FIG. 3 provides a perspective view of an overload protection adapter, according to an embodiment of the present invention.

FIG. 4 provides a schematic view of an overload protection adapter in communication with a motor and a control panel, according to an embodiment of the present invention.

### DETAILED DESCRIPTION

Reference will now be made in detail to certain embodiments of the invention, examples of which are illustrated in the accompanying drawings. While the invention will be described in reference to these embodiments, it will be understood that they are not intended to limit the invention. To the contrary, the invention is intended to cover alternatives, modifications, and equivalents that are included within the spirit and scope of the invention. In the following disclosure, specific details are given to provide a thorough understanding of the invention. However, it will be apparent to one skilled in the art that the present invention may be practiced without all of the specific details provided.

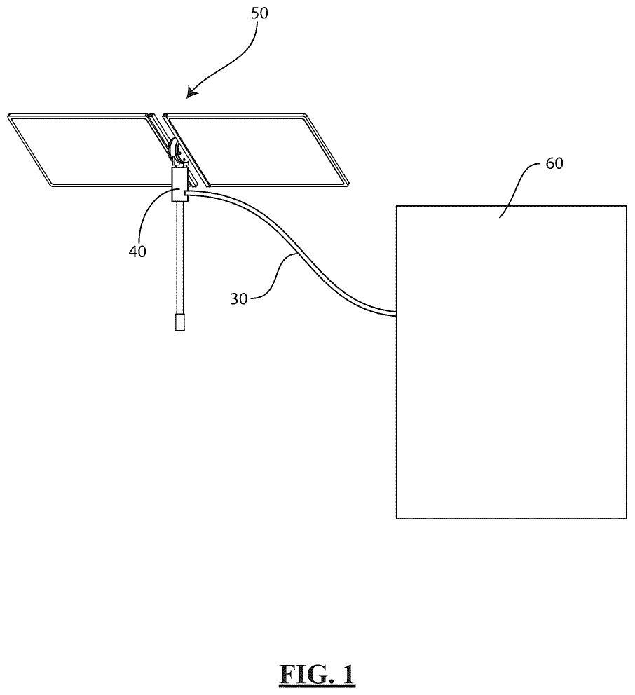

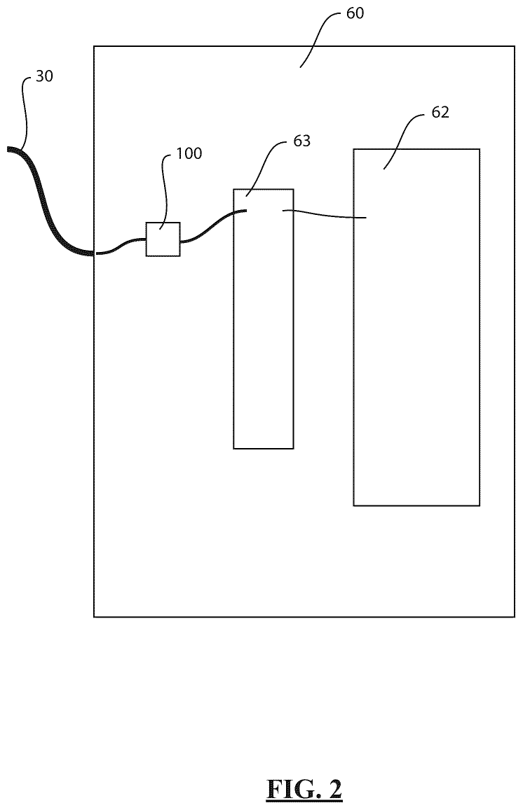

The present invention concerns an overload protection adapter incorporated into the control panel of a solar array. The solar array may include a plurality of panels and may be equipped with a solar tracking system that is operable to orient and adjust the solar panels according to the position of the sun in the sky. FIG. 1 illustrates an environmental view of solar array 50 having a motor 40 that is operable to adjust the orientation of the panels. The motor 40 may include wiring 30 that is operable to electrically the motor to a control panel 60. As illustrated in FIG. 2, the control panel 60 may include a logic board 62 that is in communication with a motor driver board 63. The overload protection adapter 100 may be connected to the output of the wiring 30 and the input of the motor driver board 63.

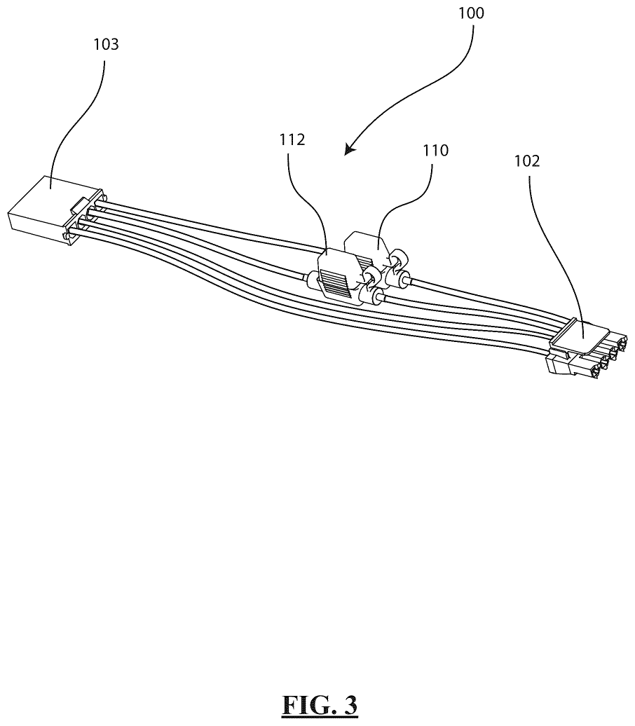

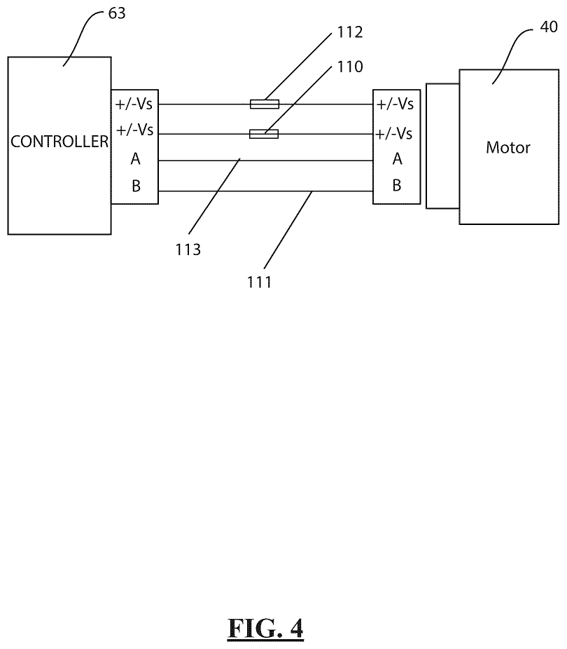

As illustrated in FIGS. 3-4, the overload protection adapter 100 may include a first connector 103 that is operable to electrically connect to the motor wiring 30 and a second connector 102 may be operable to electrically connect to the motor driver board 63. The overload protection adapter 100 may include a fuse connector 110, 112 positioned on the forward voltage line and the reverse voltage line. The fuse connector 110, 112 may be operable to prevent excessive current to the motor 40, motor driver 62, control panel 63 and wiring 30, thereby protecting the system from damage and fire. The overload protection adapter 100 is operable to configure traditional and obsolete solar tracking control panels 60 and motors 40 with protection from excessive current.

In some embodiments, the fuse connector 110, 112 may be replaced with a circuit breaker that is adapted to the motor driver board 63. For example, the circuit breaker equipped to the board may include an electronic circuit breaker, thermal circuit breaker, magnetic circuit breaker, or thermal-magnetic circuit breaker. In such embodiments the wiring 30 may be directly connected to the motor driver board 63.

In some embodiments the overload protection adapter 100, the connector 102 may be a Molex #44441-2004 housing with a Molex #43375-001 terminal and the connector 103 may be a Molex #43680-2004 housing with a Molex #43178-1002 terminal. The fuse connector 110, 112 may be an inline cable fuse and may have a receiver for axial lead fuses, blade terminal, cartridge fuse, ceramic fuse, DC Power distribution fuse, dummy fuse, fast-acting fuse, glass tube, high speed fuse, liquid fuse, medium voltage fuse, terminal fuse, and time delay fuse. The power and voltage rating of the fuse may be rated to the voltage and power rating of the motor and board.

The overvoltage protection adapter 100 is installed between the motor wiring 30 and motor driver control board 63 in the existing solar tracking system. The first connector 103 of the adapter attaches to the motor wiring 30, while the second connector 102 interfaces with the motor driver board 63. This arrangement results in all electrical signals passing through the adapter 100 before reaching the control panel 60. The adapter 100 contains inline fuse connectors 110, 112, which may include various types of fuses or a circuit breaker, depending on the system's requirements. These fuses are selected based on the voltage and current ratings of the motor 40 and control board 63.

The installed adapter 100 continuously monitors the electrical current flowing between the motor 4 and the control panel 60. If the current exceeds a predetermined threshold, indicating a potential overvoltage or overcurrent condition, the fuse within the adapter 100 will sever or the circuit breaker will trip, disconnecting the circuit and preventing excessive current from reaching the motor 40 and control board 63. The adapter 100 provides overcurrent protection from short circuit or electrical fault within the motor 40 or wiring 30, preventing high current from damaging the control board 63. It also offers surge protection against voltage surges that can occur due to lightning strikes or other external electrical disturbances.

It is to be understood that variations, modifications, and permutations of embodiments of the present invention, and uses thereof, may be made without departing from the scope of the invention. It is also to be understood that the present invention is not limited by the specific embodiments, descriptions, or illustrations or combinations of either components or steps disclosed herein. The embodiments were chosen and described in order to best explain the principles of the invention and its practical application, to thereby enable others skilled in the art to best utilize the invention and various embodiments with various modifications as are suited to the particular use contemplated. Although reference has been made to the accompanying figures, it is to be appreciated that these figures are exemplary and are not meant to limit the scope of the invention. It is intended that the scope of the invention be defined by the claims appended hereto and their equivalents.

What is claimed is:

1. An inline fuse device comprising one or more fuses in electrical connection with:
a. a solar panel tracking motor operable to adjust a position of one or more solar panels, each including at least one photovoltaic cell, and
b. a controller for providing control signals for said solar panel tracking motor, wherein at least one inline fuse connectors disconnect and open a circuit between said motor and said controller when current passing through said one or more fuses exceeds a pre-determined threshold current, said inline fuse device comprising:
i. a first connector configured to connect to motor wiring from said solar panel tracking motor;
ii. a second connector configured to connect to said controller;
iii. wherein said at least one inline fuse connector is positioned between the first and second connectors, wherein the at least one inline fuse connector is operable to house one or more fuses.

2. The inline fuse device of claim 1, wherein the one or more fuses include at least one of an axial lead fuse, blade terminal fuse, cartridge fuse, ceramic fuse, DC power distribution fuse, dummy fuse, fast-acting fuse, glass tube fuse, high-speed fuse, liquid fuse, medium voltage fuse, terminal fuse, and time delay fuse.

3. The inline fuse device of claim 1, wherein the inline fuse connector is configured to house a circuit breaker selected from the group consisting of electronic circuit breakers, thermal circuit breakers, magnetic circuit breakers, and thermal-magnetic circuit breakers.

4. The inline fuse device of claim 1, wherein the protection circuit is configured to disconnect the circuit when the current exceeds a predetermined threshold value corresponding to the rated current of the motor wiring.

5. The inline fuse device of claim 1, further comprising a resettable circuit breaker in place of the inline fuse connector.

6. The inline fuse device of claim 1, wherein the adapter is configured to retrofit existing solar panel tracking systems without replacing the motor driver control board.

7. The inline fuse device of claim 1, further comprising an environmental protective casing enclosing the first and second connectors and the inline fuse connectors.

8. The inline fuse device of claim 1, wherein the at least one protection circuit includes a thermal protection element to prevent overheating.

9. The inline fuse device of claim 1, wherein the inline fuse connector is operable to receive a bladed fuse clip that corresponds to the voltage and current rating of the motor.

10. The inline fuse device of claim 1, further comprising an indicator light that signals when the fuse is blown or the circuit breaker is tripped.

11. The inline fuse device of claim 1, further comprising a microcontroller that monitors the current and activates the protection circuit when a fault condition is detected.

12. The inline fuse device of claim 1, wherein the adapter is operable in both single-axis and dual-axis solar tracking systems.

13. The inline fuse device of claim 1, wherein the first and second inline fuse connectors are positioned within a single housing unit for compact installation.

14. The inline fuse device of claim 1, wherein the adapter is compatible with various types of solar panel tracking motors including stepper motors and servo motors.

15. The overvoltage protection adapter of claim 1, wherein the inline fuse connectors are configured to allow easy replacement of fuses without disassembling the adapter.

16. A method of preventing overvoltage in a photovoltaic system, the method comprising:
a. electrically connecting an overvoltage protection adapter with motor wiring of a solar tracker motor and a motor driver control board, the adapter comprising a first connector configured to connect to the motor wiring, a second connector configured to connect to the motor driver control board, and an inline fuse connector operable to house one or more fuses; and
b. monitoring the current flow through the motor wiring and the motor driver control board; and
c. disconnecting the circuit between the motor wiring and the motor driver control board using the inline fuse connector when the current exceeds a predetermined threshold, thereby preventing excessive current from damaging the motor driver control board.

17. The method of claim 16, wherein the overvoltage protection adapter includes a resettable circuit breaker in place of the inline fuse connector.

18. The method of claim 16, wherein the overvoltage protection adapter includes an environmental protective casing enclosing the first and second connectors and the inline fuse connectors.

19. The method of claim 16, wherein the overvoltage protection adapter includes a thermal protection element to prevent overheating.

20. The method of claim 16, wherein the overvoltage protection adapter is operable to receive a bladed fuse clip that corresponds to the voltage and current rating of the motor.
